(19) United States
(12) Patent Application Publication
(10) Pub. No.: US 2009/0267799 A1
(43) Pub. Date: Oct. 29, 2009

(54) ARRANGEMENT OF A RECORDER FOR AN AIRCRAFT MORE PARTICULARLY ADAPTED TO THE GENERAL AVIATION

(75) Inventor: Gregory LABORDE, Epinay-Sur-Orge (FR)

Correspondence Address: SUGHRUE MION, PLLC, 2100 PENNSYLVANIA AVENUE, N.W., SUITE 800, WASHINGTON, DC, 20037, US

(73) Assignee: Team, Rungis Cedex (FR)

(21) Appl. No.: 12/212,800

(22) Filed: Sep. 18, 2008

(30) Foreign Application Priority Data
Apr. 25, 2008 (FR) 08 02318

(51) Int. Cl. G08B 21/00

(52) U.S. Cl. 340/945

(57) ABSTRACT

The invention relates to an assembly intended to equip an aircraft, more particularly an aircraft having a mass of less of 5,700 kg, the assembly including an emergency locator transmitter (1) and a data recorder (10), the recorder including at least an acquisition and processing module (11) for receiving and packing the data to be recorded which is connected to at least one memory module (16) to store the data to be recorded, wherein the memory module is positioned inside the emergency locator transmitter.

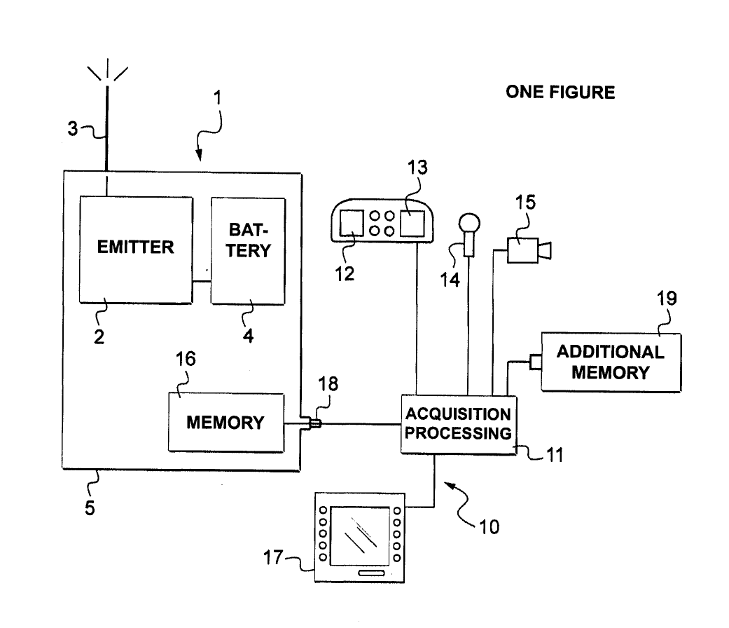

The present invention relates to an arrangement of a recorder for an aircraft more particularly adapted to the general aviation.

### BACKGROUND OF THE INVENTION

Recorders are well-known devices which enable to record several flight parameters as well as audio signals from the pilots' micros and the environment micros or even video signals from cameras positioned in the aircraft cockpit or the passengers cabin. The latter comply with very strict standards which make it possible to guarantee the integrity of the recorder and the processing of the recorded data. The standard EUROCAE ED112 more particularly imposes that such recorders must resist an acceleration of 3,400 G for 6.5 ms, resist an exposure to a 1,100° C. temperature for an hour and resist the immersion in water for thirty days.

Annex 6 part 1 of the ICAO prescribes that all aircrafts weighing more than 5,700 kg must be equipped with flight data recorders. However, nothing is provided for lighter aircrafts which fall within the general aviation. It would be interesting though to have recorded flight data or audio or video signals, in order to be able to analyse and ascertain the conditions of a possible accident with this type of aircraft. However, it appears unrealistic from an economical point of view to demand the same type of standards for aircrafts of these dimensions as those applied to the recorders of the commercial aviation. As a matter of fact, the resistance standards of the known recorders are very strict and entail very high costs as regards the acquisition and maintenance of a light aircraft.

### AIM OF THE INVENTION

The invention aims at providing a solution for recording data or audio or video signals which is the compromise resistance/acceptable cost for the general aviation.

### BRIEF DESCRIPTION OF THE INVENTION

With a view to reaching this aim, an assembly is provided which is intended to equip an aircraft, more particularly an aircraft having a mass of less of 5,700 kg, the assembly comprising an emergency locator transmitter and a data recorder, the recorder including at least one acquisition and processing module for receiving and packing data to be recorded, which is connected to at least one memory module for storing the data to be recorded, wherein according to the invention, the memory module is positioned inside the emergency locator transmitter.

Then, advantage is taken inside the aircraft of the compulsory presence of an emergency locator transmitter meeting resistance standards which, although they are not as strict as those applied to the known recorders, are sufficient however to guarantee the appropriate protection of the memory means of the recorder positioned inside the emergency locator transmitter, at least for the types of crash which the emergency locator transmitter is supposed to resist to.

Thus, without it being necessary to develop a hardened recorder specially adapted to the general aviation, a satisfactory protection of the recorded data can be provided with a small modification in existing hardened equipment, i.e. the emergency locator transmitter.

Furthermore, the positioning of the memory means in the emergency locator transmitter makes it easier to position the memory means and thus increases the capacity of finding the memory means.

Then, it will be necessary to connect the acquisition means positioned outside the emergency locator transmitter with the memory means, for example through a series connection of the USB type or through a wireless connection.

### BRIEF DESCRIPTION OF THE FIGURES

The invention will be better understood when reading the description of the only FIGURE which is a diagram of an assembly of an emergency locator transmitter and a recorder according to a particular embodiment of the invention.

### DETAILED DESCRIPTION OF THE INVENTION

While referring to the FIGURE, the assembly of the invention includes an emergency locator transmitter 1. The emergency locator transmitter 1 mainly includes an emitter 2 associated with an antenna 3 for emitting a localisation signal in case of a crash of the aircraft aboard which the emergency locator transmitter is positioned. Therefore, the emergency locator transmitter 1 includes a battery 4. The emitter 2 and the battery 4 are included in an enclosure 5 which meets the standards applicable to emergency locator transmitters, for example, the standard EUROCAE ED62. This standard more particularly requires that the emergency locator transmitter must resist an acceleration of 500 G for 4 ms or 100 G for 23 ms. It is also required that the emergency locator transmitter must resist an exposure to 1,100° C. for two minutes and also that the emergency locator transmitter must resist the immersion in water for an hour. The reader will immediately know that such requirements are much less strict than those of the standard EUROCAE ED112 mentioned hereabove relating to recorders for the commercial aviation. However, they have a high protection level.

The assembly of the invention further includes a recorder 10 comprising a data, acquisition and processing module 11. The acquisition module is adapted for receiving and packing various types of data among which:

digital data from the instruments aboard the aircraft, for example the automatic pilot 12, the motorisation controller (or FADEC) 13, or any other onboard instrument such as an airspeed indicator, a revolution meter, an accelerometer . . .

an analog audio signal from the pilots' micros 14. The acquisition module therefore includes an analog/digital converter for converting the analog audio signal into digital data;

a digital video signal from a digital camera 15 positioned in the cockpit for filming the pilots' activities and if need be the on-board instruments.

For this purpose, the acquisition and processing module 11 includes one or several connectors for connecting it to the data sources.

Of course, the abovementioned data are given only for example and a recorder can be provided within the scope of the invention, which records only one portion of the data mentioned or on the contrary other data which are not mentioned here.

The recorder also includes a memory module 16 for storing the data required by the acquisition and processing module 11. Preferably, the memory module is of the flash memory or solid state types.

Furthermore, the acquisition and processing module 11 is connected to an interface module 17 including a screen and controls allowing the pilot to control the acquisition and processing module 11 and more particularly to read the data which have already been recorded in the memory module 16.

According to the invention, the memory module 16 is positioned inside the emergency locator transmitter 1. The memory module 16 is connected to the acquisition and processing module 11 for a series wire connection, for example of the USB type. For this purpose, the emergency locator transmitter is provided with a connector 18 through which the acquisition and processing module 11 can be connected to the memory module 16 positioned in the emergency locator transmitter 11. Of course, other types of connections such as an ETHERNET connection or a wireless connection may be provided while remaining within the scope of the invention.

The memory module 16 is thus sheltered so that in case of a crash or an accident the intensity of which does not question the integrity of the emergency locator transmitter, it is possible to find the memory module of the recorder and thus to process the recorded data.

The advantages of the invention are numerous:

the positioning of a memory module in the emergency locator transmitter gives the memory in a very simple and very economical way, a level of protection which remains high even though it does not reach that provided by the recorders designed according to standard ED112;

the positioning of the memory module is extremely simple because of its direct positioning within the emergency locator transmitter. Finding the emergency locator transmitter as it is emitting for this purpose, makes it possible to find the memory module too;

the memory module thus protected does not require to be hardened or protected separately. A simple commercially available memory module is appropriate if it is appropriately protected within the emergency locator transmitter;

the modification in the emergency locator transmitter according to the invention is minimum and has a very low cost which is acceptable for the general aviation.

Various alternative solutions of the illustrated embodiment may be considered while remaining within the scope of the invention as defined by the claims.

According to a first alternative solution, the recorder may be equipped with means for the connection to an additional memory module 19 which is not positioned in the emergency locator transmitter, so that the additional memory module does not have the protection of the emergency locator transmitter. For example, the additional memory module 19 may be directly plugged on the processing and acquisition module or be plugged on a connector positioned outside the emergency locator transmitter. The additional memory module 19 is adapted for recording the same data as that which are recorded in the memory module 16 positioned in the emergency locator transmitter. However, the additional memory module 19 will be advantageously designed to be removable, so that it is possible to collect it at the end of each flight to read the data on a ground-based computer and thus replay the flight which has just ended.

According to another alternative solution, the acquisition and processing module 11 is also inserted into the emergency locator transmitter so that it is protected as the memory module 16. The assembly is particularly compact since the recorder is now totally incorporated within the emergency locator transmitter which is equipped with the corresponding connectors for the connection of the recorder to the data sources as well as to the power supply.

Of course, the emergency locator transmitter may be designed to be built in the aircraft, but it can also be provided to be removable so that it can be easily collected from the aircraft and used on another aircraft. Then, the emergency locator transmitter should be connected to the acquisition and processing module or, if the latter is positioned inside the emergency locator transmitter, to the data sources and to the power supply.

1. An assembly intended to equip an aircraft more particularly an aircraft having a mass of less than 5,700 kg, the assembly comprising an emergency locator transmitter (1) and a data recorder (10), the recorder including at least one acquisition and processing module (11) for receiving and packing data to be recorded which is connected to at least one memory module (16) FOR storing the data to be recorded, wherein the memory module is positioned inside the emergency locator transmitter.

2. An assembly according to claim 1, wherein the recorder includes an additional removable memory module (19) which is positioned outside the emergency locator transmitter.

3. An assembly according to claim 1, wherein the acquisition and processing module (11) is also positioned inside the emergency locator transmitter.
